(19) United States
(12) Patent Application Publication
(10) Pub. No.: US 2010/0162601 A1
(43) Pub. Date: Jul. 1, 2010

(54) DEVICE FOR ADVERTISEMENT

(76) Inventor: Byung-Man Kim, Cheongju-city (KR)

Correspondence Address: Daniel P. Burke, Esq.;Daniel P. Burke & Associates, PLLC, 240 Townsend Square, Oyster Bay, NY, 11771, US

(21) Appl. No.: 11/921,425

(22) PCT Filed: Jun. 13, 2006
(86) PCT No.: PCT/KR2006/002248

§ 371 Date: Nov. 30, 2007

(30) Foreign Application Priority Data
Jul. 20, 2005 (KR) 10-2005-0065728
Oct. 26, 2005 (KR) 10-2005-0101142

(51) Int. Cl. G09F 19/02

(52) U.S. Cl. 40/514

(57) ABSTRACT

Disclosed herein is an auxiliary advertisement device (100, 200). The auxiliary advertisement device include a frame (110, 210) secured to a newspaper, a free newspaper, an outer cover of a book, such as a phone book, a paper bag, a cardboard box, or a writing instrument, such as a ball-point pen, and an auxiliary advertisement sheet (230) that contains auxiliary advertisement contents and is continuously unwound from the frame (110, 210) and wound in the frame (110, 210) in the form of a roll, thus overcoming space limitations of the advertising object, and arousing the curiosity of consumers, therefore maximizing the advertising effect.

### TECHNICAL FIELD

The present invention relates, in general, to an auxiliary advertisement device mounted to a newspaper, a free newspaper, a book, a paper bag, a writing instrument, etc. and, more particularly, to an auxiliary advertisement device, including a frame and an auxiliary advertisement sheet which contains advertisement contents or presents the main points of a book in brief and is continuously unwound from the frame and wound in the frame in the form of a roll, thus overcoming space limitations and arousing the curiosity of consumers, therefore maximizing the advertising effect.

### BACKGROUND ART

Generally, a daily publication, such as a newspaper, especially a free newspaper, a book, such as a phone book, and other various publications provide various and useful information to busy people in modern society. As representative examples, many box advertisements are inserted in free newspapers or phone books.

In the case of the box advertisement, since a plurality of advertisements must be run in limited space, only a shop name and a main phone number of an advertiser are indicated.

Recently, in order to attract the attention of consumers and arouse the consumers' interest, a box advertisement has been developed to have various colors and designs. However, such a box advertisement has only a two-dimensional shape.

Further, a publication also has a conventional shape. Even when a person desires to look the brief contents of the publication, he or she must turn over the leaves of the publication.

### DISCLOSURE OF INVENTION

### Technical Problem

Accordingly, the present invention has been made keeping in mind the above problems occurring in the prior art, and an object of the present invention is to provide an auxiliary advertisement device, including a frame mounted to a binding part or a first page of a book and an auxiliary advertisement sheet which contains advertisement contents or presents the main points of a book in brief and is continuously unwound from the frame and wound in the frame in the form of a roll, thus overcoming space limitations and arousing the curiosity of consumers, therefore maximizing the advertising effect.

### Technical Solution

In order to accomplish the object, the present invention provides an auxiliary advertisement device for a publication including a main body on which literary works, such as documents, paintings or photographs, are printed, with a binding part being provided on an end of the main body, and a cover closing a front surface, a back surface, and the binding part of the main body. One or more auxiliary advertisement devices are disposed between the binding part and the cover in such a way as to be movable in and out the cover. Text contents are printed on each auxiliary advertisement device.

Each auxiliary advertisement device includes a frame and an auxiliary advertisement sheet. The frame has a housing having a shape of a vertical tube, with a gate hole being formed in a side of the housing to extend from a first end to a second end of the housing, and has flanges closing open opposite ends of the housing. The auxiliary advertisement sheet includes an elastic support which is positioned in the housing and is secured at opposite ends thereof to the flanges, and a sheet which is disposed in the housing while being wound around the elastic support, the sheet being taken out of the housing and thereafter being wound around the elastic support again.

Further, the present invention provides an auxiliary advertisement device, including a frame which has a vertical bar secured to an advertising object, horizontal bars integrally provided on opposite ends of the vertical bar, and an elastic member wound in one direction and positioned between the horizontal bars, and an auxiliary advertisement sheet which has a sheet containing auxiliary advertisement contents, the sheet being continuously unwound from the elastic member and wound around the elastic member in a form of a roll.

Preferably, each of the horizontal bars includes a fastening hole to fasten an end of the elastic member, the elastic member comprising an elastic cord having superior elastic restoring force.

Further, the sheet has a width which is smaller than a distance between the horizontal bars and extends to a predetermined position, and the sheet is wound around the elastic cord while a first end of the sheet is attached to the elastic cord, with a tag mounted to a second end of the sheet to allow the sheet to be easily unwound from the elastic cord.

### BRIEF DESCRIPTION OF THE DRAWINGS

FIG. 1 is a perspective view showing a publication having an auxiliary advertisement device, according to the first embodiment of the present invention;

FIG. 2 is an exploded perspective view of the auxiliary advertisement device of FIG. 1;

FIG. 3 is a sectional view taken along line A-A of FIG. 1;

FIG. 4 is a sectional view taken along line B-B of FIG. 1;

FIG. 5 is a perspective view showing the state where the auxiliary advertisement device of FIG. 2 is mounted to the outer portion of the publication;

FIG. 6 is a view showing the use of the publication to which the auxiliary advertisement device according to this invention is mounted;

FIG. 7 is a perspective view showing an auxiliary advertisement device, according to the second embodiment of the present invention;

FIG. 8 is a view showing the assembled state of the auxiliary advertisement device of FIG. 7; and

FIGS. 9 to 15 are views showing the state where the auxiliary advertisement device of FIG. 7 is mounted.

### BEST MODE FOR CARRYING OUT THE INVENTION

Hereinafter, auxiliary advertisement devices according to the preferred embodiments of the present invention will be described with reference to the accompanying drawings.

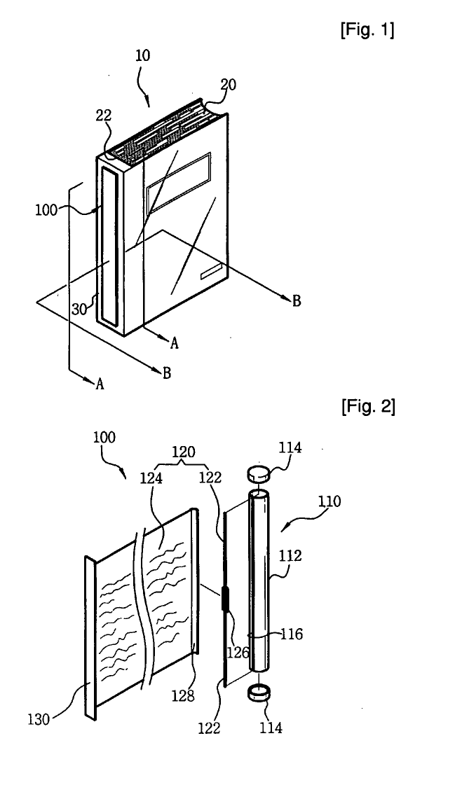

FIG. 1 is a perspective view showing a publication having an auxiliary advertisement device, according to the first embodiment of the present invention.

Referring to FIG. 1, the publication 10 according to the present invention includes a main body 20, a cover 30, and an auxiliary advertisement device 100. Literary works, such as documents, paintings, and photographs, are printed in the main body 20, with a binding part 22 provided on an end of the main body 20. The cover 30 closes the front and back surfaces of the main body 20 and the binding part 22. At least one auxiliary advertisement device 100 is disposed between the binding part 22 of the main body 20 and the cover 30, and is movable out of the cover 30.

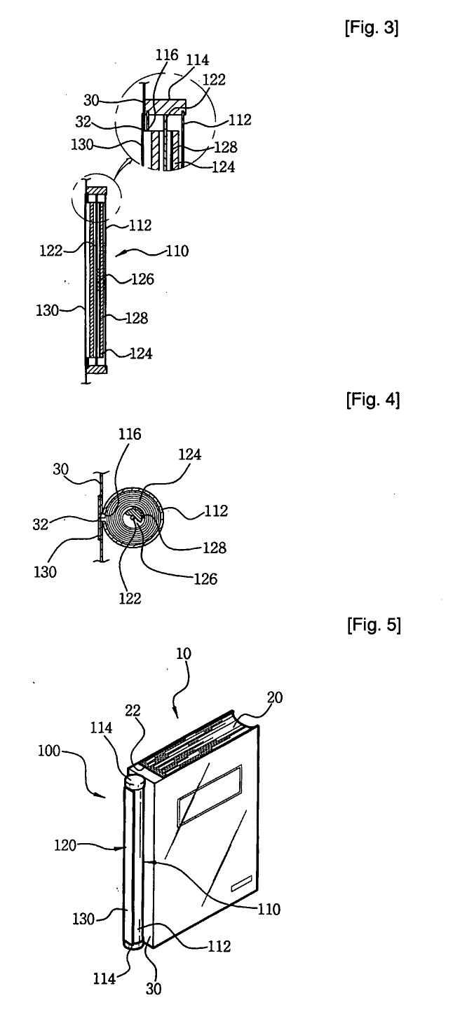

FIG. 2 is an exploded perspective view of the auxiliary advertisement device of FIG. 1, FIG. 3 is a sectional view taken along line A-A of FIG. 1, and FIG. 4 is a sectional view taken along line B-B of FIG. 1.

Referring to FIGS. 2 to 4, the auxiliary advertisement device 100 includes a frame 110 and an auxiliary advertisement sheet 120. The frame 110 is placed between the outer portion of the binding part 22 and the inner portion of the cover 30. The auxiliary advertisement sheet 120 is provided in the frame 110 and is movable out of the frame 110.

The frame 110 is provided with a housing 112 having the shape of a vertical tube, and flanges 114 closing open opposite ends of the housing 112. In this case, a gate hole 116 is formed in a predetermined portion of the housing 112 to face the inner surface of the cover 30. Such a gate hole 116 extends from one end of the housing 112 to the other end thereof. The auxiliary advertisement sheet 120 is disposed in the housing 112 of the frame 110, which is thus constructed.

The auxiliary advertisement sheet 120 includes an elastic support 122 and a sheet 124. The elastic support 122 is disposed in the housing 112. The sheet 124 is placed in the housing 112 and is wound around the elastic support 122. In this case, the sheet is pulled out of the housing 112 and the cover 30 when desired. Subsequently, the sheet winds around the elastic support 122 again.

The elastic support 122 is a general elastic cord having elastic force. The opposite ends of the elastic support 122 are secured to the inner surfaces of the facing flanges 114. In this case, a coupler 126, having the shape of a curved plate, is integrally provided in the central portion of the elastic support 122. Preferably, the elastic support 122 secured to the facing flanges 114 is wound in one direction.

Meanwhile, the entire contents of the main body 20 of the publication 10 are printed on the sheet 124, the contents of the main body 20 are summarized on the sheet 124, or advertisement contents are printed on the sheet 124. In such a state, the sheet 124 is wound around the elastic support 122. A coupling rib 128 having the shape of a curved plate is integrally provided on one end of the sheet 124, thus allowing the sheet to be smoothly wound around or unwound from the elastic support 122. The inner curvature of the coupling rib 128 is almost equal to the curvature of the outer circumferential surface of the coupler 126. The coupling rib 128 is secured through a general thermal fusing method. Preferably, the coupling rib 128 and the coupler 126 may be coupled to each other via a general clip or a general adhesive.

Further, a tag 130 placed on the outer surface of the cover 30 is integrally provided on the other end of the sheet 124. That is, the tag 130 prevents the sheet 124 from completely entering the housing 116. Meanwhile, a through hole 32 is formed in the cover 30 in such a way as to face the gate hole 116 of the housing 112, so that the sheet 124 may pass through the cover 30.

FIG. 5 is a perspective view showing the state where the auxiliary advertisement device of FIG. 2 is mounted to the outer portion of the publication.

As shown in the drawing, at least one auxiliary advertisement device 100 according to the present invention may be mounted to the outer surface of the cover 30 to face the binding part 22.

Hereinafter, the operation of the auxiliary advertisement device 100 constructed as described above will be described in brief.

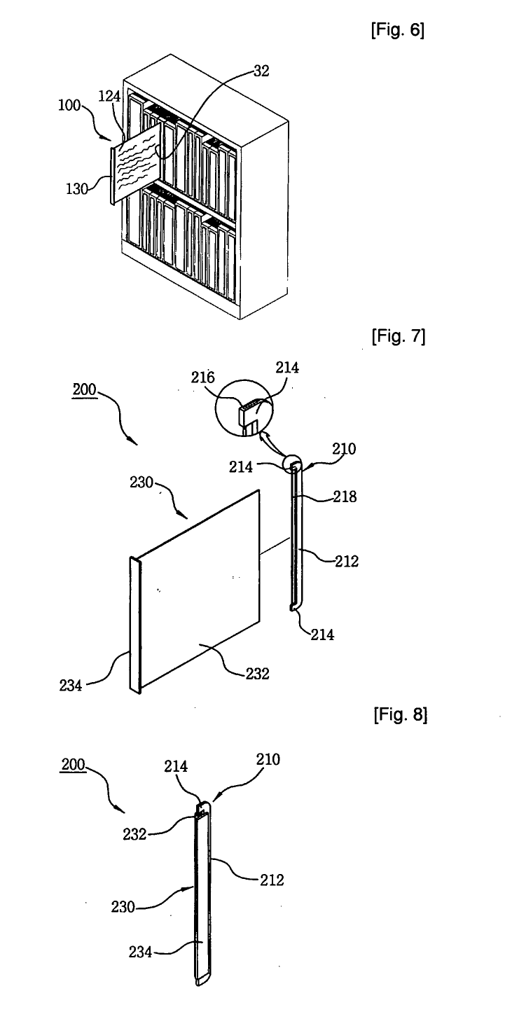

FIG. 6 is a view showing the use of the publication to which the auxiliary advertisement device according to this invention is mounted. As shown in the drawing, in order to look at the contents of the main body 20 of the publication 10 arranged on a display shelf, a reader pulls the tag 130 out of the cover 30. When the tag 130 is thus pulled, the sheet 124 is unwound from the elastic support 122, and passes through the gate hole 116 of the housing 112 and the through hole 32 of the cover 30, and is thus exposed outside the cover 30. At this time, the elastic support 122 secured at opposite ends thereof to the flanges 114 is rotated in one direction and wound by the sheet 124 which is unwound from the elastic support 122 and is exposed outside.

In such a state, the reader looks at the contents of the publication 10, and then releases the tag 130 from his or her hand. Thereby, the elastic support 122, which has been wound in one direction, rotates in the opposite direction. As a result, the sheet 124 exposed outside the cover 30 is guided into the housing 112 again, and is wound around the elastic support 122, which rotates in the opposite direction. The tag 130 comes into close contact with the outer portion of the cover 30.

FIG. 7 is an exploded perspective view showing an auxiliary advertisement device, according to the second embodiment of the present invention, and FIG. 8 is a view showing the assembled state of the auxiliary advertisement device of FIG. 7.

Referring to FIGS. 7 and 8, the auxiliary advertisement device 200 according to the present invention includes a frame 210 and an auxiliary advertisement sheet 230 which contains advertisement contents and is continuously unwound from and wound in the frame 110 in the form of a roll.

The frame 210 includes a vertical bar 212, horizontal bars 214 integrally provided on opposite ends of the vertical bar 212, and an elastic support 218 secured between the horizontal bars 214.

Preferably, each of the vertical bar 212 and the horizontal bars 214 is manufactured to have the shape of a thin plate. More preferably, each of the vertical bar 212 and the horizontal bars 214 is manufactured to have a cylindrical shape.

Each horizontal bar 214 extends from the vertical bar 212 in such a way as to be perpendicular to the longitudinal direction of the vertical bar 212. That is, the vertical bar 212 and the horizontal bars 214 are manufactured to have a “]” shape. Fastening holes 216 are formed in the horizontal bars 214, so that the opposite ends of the elastic support 218 are fastened to the corresponding fastening holes 216.

The elastic support 218 comprises an elastic cord having superior elastic restoring force. One end of the elastic support 218 is fastened to the fastening hole 216 of one of the horizontal bars 214, while the other end of the elastic support 218 is fastened to the fastening hole 216 of the other horizontal bar 214. In order to increase the elastic restoring force of the elastic support 218, the elastic support 218 is wound in one direction 12 to 13 times. In such a state, the opposite ends of the elastic support 218 are fastened to the fastening holes 216 of the horizontal bars 214. Preferably, the opposite ends of the elastic support 218 may be knotted to the corresponding fastening holes 216. Alternatively, the opposite ends of the elastic support 218 may be attached to the fastening holes 216 using an adhesive, after being passed through the corresponding fastening holes 216. The auxiliary advertisement sheet 230 is thus mounted to the frame 110.

The auxiliary advertisement sheet 230 includes a sheet 232 on which various advertising text is written or advertising pictures are shown. The sheet 232 extends between the horizontal bars 214, and has a width smaller than the distance between the horizontal bars 214. While one end of the sheet 232 is attached to the elastic support 218, the sheet 232 is wound around the elastic support 218.

A tag 234 is mounted to the other end of the sheet 232 and wound around the elastic support 218, so as to allow a user to pull the auxiliary advertisement sheet 230. In order to prevent the tag 234 from being wound around the elastic support 218 along with the sheet 232, the central portion of one surface of the tag 234 is attached to the other end of the sheet 232 in such a way that the tag 234 is perpendicular to the sheet 232. Preferably, the tag 234 is manufactured so as to be wider than each horizontal bar 214.

The use of the auxiliary advertisement device 200 constructed as described above will be described below in brief.

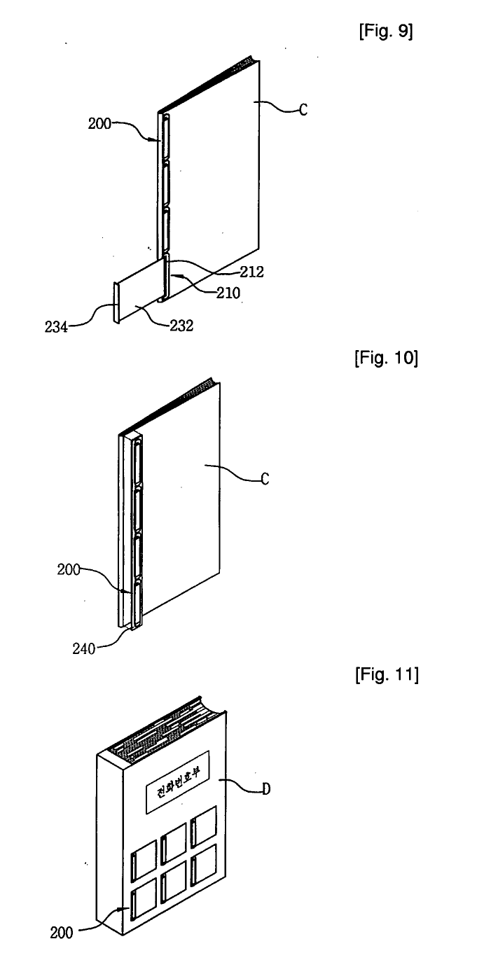

FIGS. 9 to 15 are views showing the mounted state of the auxiliary advertisement device of FIG. 7.

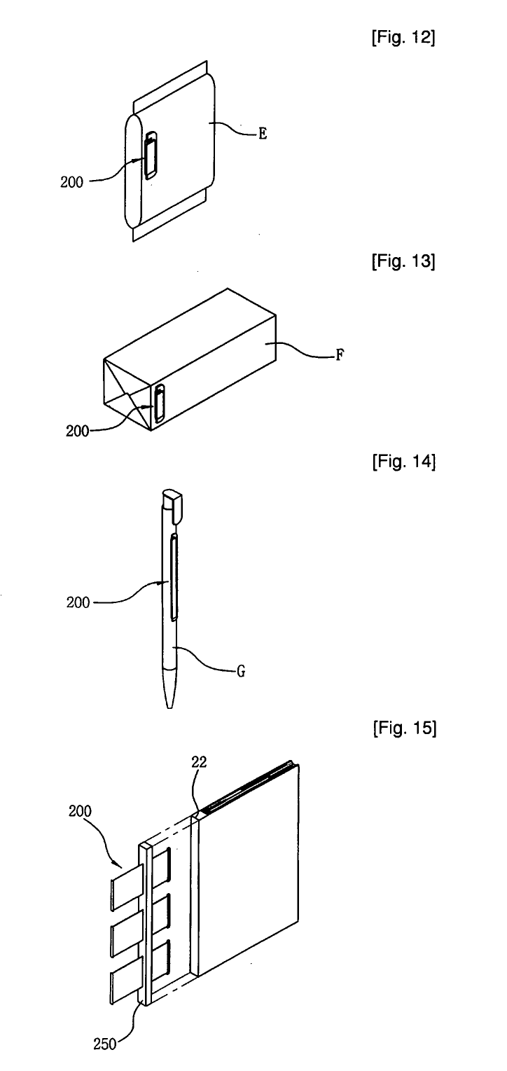

Referring to FIGS. 9 to 15, an advertisement is inserted in the auxiliary advertisement sheet 230 of the auxiliary advertisement device 200 according to the present invention. In such a state, the vertical bar 212 of the frame 210 is mounted to a portion of an object C, D, E, F, or G carrying advertisements, that is, a free newspaper C (see, FIGS. 9 and 10), such as a newspaper, a book, especially a phone book D (see, FIG. 11), a paper bag E (see, FIG. 12), a cardboard box F (see, FIG. 13), or a writing instrument G (see, FIG. 14), such as a ball-point pen. In this case, the auxiliary advertisement device 200 is mounted to the outer portion of the writing instrument G. Preferably, the frame 210 is attached to the portion of the object carrying the advertisement using a general adhesive.

As such, when the frame 210 in which the auxiliary advertisement sheet 230 is wound is mounted to the advertisement-carrying object C, D, E, F, G, which is delivered to a consumer, the consumer pulls the tag 234 so as to check advertisement contents. At this time, the sheet 232 is unwound while rotating the elastic support 218 to wind it in one direction. Thereby, the consumer looks at the advertisement contents which are put in the auxiliary advertisement sheet 230.

After the consumer has looked the contents described in the sheet 232, he or she releases the tag 234 from his or her hand. At this time, the sheet 232 is wound around the elastic support 218 by the restoring force of the elastic support 218 again, and the tag 234 comes into close contact with the frame 210.

Meanwhile, as shown in FIG. 10, in order to attach a plurality of auxiliary advertisement devices 200, an additional adhesive sheet 240 may be provided between the vertical bar 212 of the frame 210 and the free newspaper C. The adhesive sheet 240 and the vertical bar 212 or the adhesive sheet 240 and the free newspaper C may be attached to each other using a general adhesive.

Further, as shown in FIG. 11, the auxiliary advertisement device 200 is mounted beside a box advertisement to supplement the contents of the box advertisement. Preferably, the auxiliary advertisement device 200 may be mounted beside a box advertisement of a free newspaper C. In this case, either the frame 210 or the tag 234 is placed on the side of the box advertisement.

Meanwhile, as shown in FIG. 15, the auxiliary advertisement device 200 has an additional casing 250 in the binding part 22 of a publication. The auxiliary advertisement device 200 is mounted such that the sheet 232 of the auxiliary advertisement sheet 230 is movable in and out. In this case, the frame 210 or the tag 234 is not attached to the casing 250.

### INDUSTRIAL APPLICABILITY

As described above, the present invention provides an auxiliary advertisement device 100, 200 which includes a frame 110, 210 secured to a newspaper or a free newspaper C, a book, especially a phone book D, a paper bag E or a cardboard box F, and an auxiliary advertisement sheet 230 that contains auxiliary advertisement contents and is continuously unwound from the frame 110, 210 and wound in the frame 110, 210 in the form of a roll, thus overcoming space limitations of the advertising object C, D, E, and F, and arousing the curiosity of consumers, therefore maximizing the advertising effect.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. An auxiliary advertisement device for a publication comprising a main body on which literary works, such as documents, paintings or photographs, are printed, with a binding part being provided on an end of the main body, and a cover closing a front surface, a back surface, and the binding part of the main body, the auxiliary advertisement device comprising:
at least one frame provided between the binding part and the cover, and comprising:
a housing comprising a shape of a vertical tube, with a gate hole being formed in a side of the housing to extend from a first end to a second end of the housing; and flanges closing open opposite ends of the housing; and
an auxiliary advertisement sheet, comprising:
an elastic support positioned in the housing and secured at opposite ends thereof to the flanges; and
a sheet disposed in the housing while being wound around the elastic support, the sheet being taken out of the housing and thereafter being wound around the elastic support again.

2. The auxiliary advertisement device according to claim 1, wherein the elastic support comprises an elastic cord comprising elastic force, and a coupler comprising a shape of a curved plate is integrally formed on a central portion of the elastic support to allow the sheet to be easily wound around the elastic support.

3. The auxiliary advertisement device according to claim 1, wherein a coupling rib is integrally provided on a first end of the sheet and is coupled to the coupler through thermal fusion, a tag is integrally provided on a second end of the sheet to be positioned outside the cover, and a through hole is formed in the cover to allow the sheet to pass through the cover.

4. The auxiliary advertisement device according to claim 1, wherein one or more auxiliary advertisement devices are provided on an outer portion of the cover to face the binding part.

5. An auxiliary advertisement device, comprising:
a frame comprising:
a vertical bar secured to an advertising object;
horizontal bars integrally provided on opposite ends of the vertical bar; and
an elastic support wound in one direction and positioned between the horizontal bars; and
an auxiliary advertisement sheet comprising:
a sheet containing auxiliary advertisement contents, the sheet being continuously unwound from the elastic support and wound around the elastic support in a form of a roll.

6. The auxiliary advertisement device according to claim 5, wherein each of the horizontal bars comprises a fastening hold to fasten an end of the elastic support, the elastic support comprising an elastic cord comprising superior elastic restoring force.

7. The auxiliary advertisement device according to claim 5, wherein the sheet has a width which is smaller than a distance between the horizontal bars and extends to a predetermined position, and the sheet is wound around the elastic support while a first end of the sheet is attached to the elastic support, with a tag mounted to a second end of the sheet to allow the sheet to be easily unwound from the elastic support.

8. The auxiliary advertisement device according to claim 7, wherein a center of a surface of the tag is attached to the second end of the sheet in such a way that the tag is perpendicular to the second end of the sheet, thus preventing the tag from being wound around the elastic support along with the sheet.

9. The auxiliary advertisement device according to claim 5, wherein at least one auxiliary advertisement device is mounted to the advertising object, the advertising object being selected from a group consisting of a newspaper, a free newspaper, a phone book, a paper bag, a cardboard box, a writing instrument, and a publication.

10. The auxiliary advertisement device according to claim 9, wherein the auxiliary advertisement device is mounted to a portion of the free newspaper, the phone book, the packaging bag, or the cardboard box, or to an outer portion of the writing instrument.

11. The auxiliary advertisement device according to claim 9, wherein the auxiliary advertisement device is mounted beside a box advertisement of the free newspaper or the phone book, thus supplementing advertisement contents of the box advertisement.

12. The auxiliary advertisement device according to claim 5, wherein an additional adhesive sheet is provided between the auxiliary advertisement device and the free newspaper for attachment of a plurality of auxiliary advertisement devices to the free newspaper.

13. The auxiliary advertisement device according to claim 5, wherein the auxiliary advertisement device has a casing in the binding part of the publication, and the sheet is mounted in such a way as to be movable in and out the casing.

14. The auxiliary advertisement device according to claim 2, wherein a coupling rib is integrally provided on a first end of the sheet and is coupled to the coupler through thermal fusion, a tag is integrally provided on a second end of the sheet to be positioned outside the cover, and a through hole is formed in the cover to allow the sheet to pass through the cover.

15. The auxiliary advertisement device according to claim 2, wherein one or more auxiliary advertisement devices are provided on an outer portion of the cover to face the binding part.

16. The auxiliary advertisement device according to claim 6, wherein the sheet has a width which is smaller than a distance between the horizontal bars and extends to a predetermined position, and the sheet is wound around the elastic support while a first end of the sheet is attached to the elastic support, with a tag mounted to a second end of the sheet to allow the sheet to be easily unwound from the elastic support.

17. The auxiliary advertisement device according to claim 9, wherein an additional adhesive sheet is provided between the auxiliary advertisement device and the free newspaper for attachment of a plurality of auxiliary advertisement devices to the free newspaper.

18. The auxiliary advertisement device according to claim 9, wherein the auxiliary advertisement device has a casing in the binding part of the publication, and the sheet is mounted in such a way as to be movable in and out the casing.
